(19) United States
(12) Patent Application Publication
(10) Pub. No.: US 2019/0107189 A1
(43) Pub. Date: Apr. 11, 2019

(54) METHOD FOR DESIGNING TRANSMISSION DEVICE, METHOD FOR MANUFACTURING TRANSMISSION DEVICE, AND METHOD FOR MANUFACTURING VARIABLE SPEED INCREASER

(71) Applicant: MITSUBISHI HEAVY INDUSTRIES COMPRESSOR CORPORATION, Tokyo (JP)

(72) Inventors: Masahiro Kobayashi, Hiroshima-shi (JP); Yasushi Mori, Hiroshima-shi (JP)

(73) Assignee: MITSUBISHI HEAVY INDUSTRIES COMPRESSOR CORPORATION, Tokyo (JP)

(21) Appl. No.: 16/099,408

(22) PCT Filed: Jul. 20, 2016
(86) PCT No.: PCT/JP2016/071242

§ 371 Date: Nov. 6, 2018

(51) Int. Cl. F16H 57/00; H02K 7/116; H02K 9/06

(52) U.S. Cl. CPC F16H 57/00; H02K 7/116; F16H 3/725; F16H 2057/0087; H02K 9/06

(57) ABSTRACT

This method for designing a transmission device includes: a body part design step for designing a body part having an internal gear in which a plurality of teeth are aligned in a ring shape; a gear unit part design step in which a plurality of gear unit parts, each having a planetary gear that meshes with a sun gear, that revolves about an axis line and rotates about its own center line, and that is capable of meshing with the internal gear, are designed so as to have different gear ratios and to have the same outside diameter; and a gear unit part selection step for selecting one gear unit part from the plurality of gear unit parts.

### TECHNICAL FIELD

The present invention relates to a method for designing a transmission device, a method for manufacturing a transmission device, and a method for manufacturing a variable-speed speed-up mechanism.

### BACKGROUND ART

As a device which drives a rotary machine, such as a compressor, there is a variable-speed speed-up mechanism equipped with an electric device which generates a rotational driving force and a transmission device which changes the rotational driving force generated by the electric device and transmits the rotational driving force to the rotary machine. In the variable-speed speed-up mechanism, the gear ratio of the transmission device changes in accordance with the required specifications. Therefore, it is necessary to rearrange the transmission device in accordance with the required specifications.

For example, Patent Document 1 describes a structure for changing the gear ratio of a simple planetary roller used in a geared motor after use, as a structure that corresponds to the required specifications. In the geared motor described in Patent Document 1, a simple planetary roller mechanism having a ring roller in which a planetary roller that is in rolling contact with an outer circumference of a sun roller is provided. In the geared motor, by interposing the simple planetary roller mechanism between a transmission unit and a motor unit, it is possible to flexibly change the gear ratio in accordance with the required specifications.

Incidentally, in a case where the transmission device used in the variable-speed speed-up mechanism has a planetary gear structure, in order to manufacture a transmission device that corresponds to the required gear ratio, the number of gears that need to be newly designed becomes extremely large.

### CITATION LIST

### Patent Literature

[Patent Document 1] Japanese Patent No. 4368013

### SUMMARY OF INVENTION

### Technical Problem

However, as the number of gears that need to be newly designed becomes extremely large, it is necessary to spend a lot of design time in order to manufacture the transmission device that corresponds to the required specifications. In addition, in a case of changing the specification of the variable-speed speed-up mechanism while in use, it is necessary to replace the transmission device itself. As a result, the production period is prolonged and the cost increases. Therefore, it is desirable to obtain transmission devices having different gear ratios while limiting the production period and cost.

The present invention provides a method for designing a transmission device, a method for manufacturing a transmission device, and a method for manufacturing a variable-speed speed-up mechanism, which are capable of obtaining transmission devices having different gear ratios while limiting the manufacturing period and cost.

### Solution to Problem

According to a first aspect of the present invention, there is provided a method for designing a transmission device for changing a speed of a rotational driving force generated by an electric device which is configured to generate the rotational driving force and transmitting the rotational driving force to a target to be driven, the method including: a main body portion designing step of designing a main body portion including an internal gear having a plurality of teeth which are annularly arranged around an axis line, an internal gear carrier shaft which is configured to extend in an axial direction around the axis line, and an internal gear carrier supporting the internal gear to be rotatable around the axis line; a gear unit portion designing step of designing a plurality of gear unit portions each including a sun gear which is configured to rotate around the axis line, a sun gear shaft which is fixed to the sun gear and which is configured to extend in the axial direction around the axis line, and a planetary gear which is capable of meshing with the sun gear, revolving around the axis line and rotating around a center line thereof, and meshing with the internal gear, so as to have different gear ratios and to have the same outer diameter; and a gear unit portion selecting step of selecting one gear unit portion from the plurality of gear unit portions designed in the gear unit portion designing step.

According to the configuration, a part having many gears, such as a planetary gear or a sun gear, can be set as a gear unit portion. By designing a plurality of gear unit portions with the same outer shape but different gear ratios, it is possible to standardize the design of the main body portion regardless of the required gear ratio. Therefore, it is possible to obtain design information of a plurality of transmission devices adapted to a compressor which requires different outputs or rotational speeds, without redesigning the entire transmission device including a location to be connected to another device or the like.

According to a second aspect of the present invention, in the method for designing a transmission device in the first aspect, in the gear unit portion designing step, the gear ratio may be determined with the revolving rotational speed of the planetary gear to be constant.

According to the configuration, by designing a plurality of gear unit portions with the revolving rotational speed of the planetary gear to be constant, even in a case where the rotational speed of the target to be driven changes, it is not necessary to adjust the gear specification of the internal gear transmitted to the planetary gear. Therefore, even in a case where the rotational speed of the target to be driven changes, it is possible to obtain the transmission device that corresponds to the target to be driven simply by replacing the gear unit portion while limiting the production period and cost.

According to a third aspect of the present invention, there is provided a method for manufacturing a transmission device, including: a design information acquiring step of acquiring design information of the main body portion and the gear unit portion according to the method for designing a transmission device according to the first or second aspect; a main body portion manufacturing step of manufacturing the main body portion according to the design information of the main body portion acquired in the design information acquiring step; a gear unit portion manufacturing step of manufacturing the gear unit portion according to design information of the gear unit portion acquired in the design information acquiring step; and a transmission device assembling step of attaching and assembling the gear unit portion manufactured in the gear unit portion manufacturing step to the main body portion manufactured in the main body portion manufacturing step.

According to the configuration, it is possible to manufacture a transmission device according to design information of a transmission device designed while limiting the production period and cost.

According to a fourth aspect of the present invention, there is provided a method for manufacturing a variable-speed speed-up mechanism, including: a transmission device acquiring step of acquiring the transmission device according to the method for manufacturing the transmission device according to the third aspect; an electric device manufacturing step of manufacturing the electric device including a constant-speed electric motor having a constant-speed rotor which is configured to be connected directly or indirectly to a constant-speed input shaft of the transmission device, and a variable-speed electric motor having a variable-speed rotor which is configured to be connected directly or indirectly to the variable-speed input shaft of the transmission device; and a transmission device attaching step of attaching the transmission device to the electric device manufactured in the electric device manufacturing step such that the sun gear shaft forms an output shaft connected to a target to be driven and the internal gear carrier shaft forms the constant-speed input shaft.

According to the configuration, it is possible to manufacture the variable-speed speed-up mechanism in a short period of time by limiting the manufacturing period of the transmission device.

### Advantageous Effects of Invention

According to the present invention, it is possible to obtain transmission devices having different gear ratios while limiting the production period and cost.

### BRIEF DESCRIPTION OF DRAWINGS

FIG. 1 is a sectional view of a variable-speed speed-up mechanism of an embodiment according to the present invention.

FIG. 2 is a sectional view of a transmission device of the embodiment according to the present invention.

FIG. 3 is a sectional view of the electric device of the embodiment according to the present invention.

FIG. 4 is a schematic view showing a configuration of the transmission device according to the embodiment of the present invention.

FIG. 5 is a flowchart showing a method for manufacturing a variable-speed speed-up mechanism of the embodiment of the present invention.

### DESCRIPTION OF EMBODIMENTS

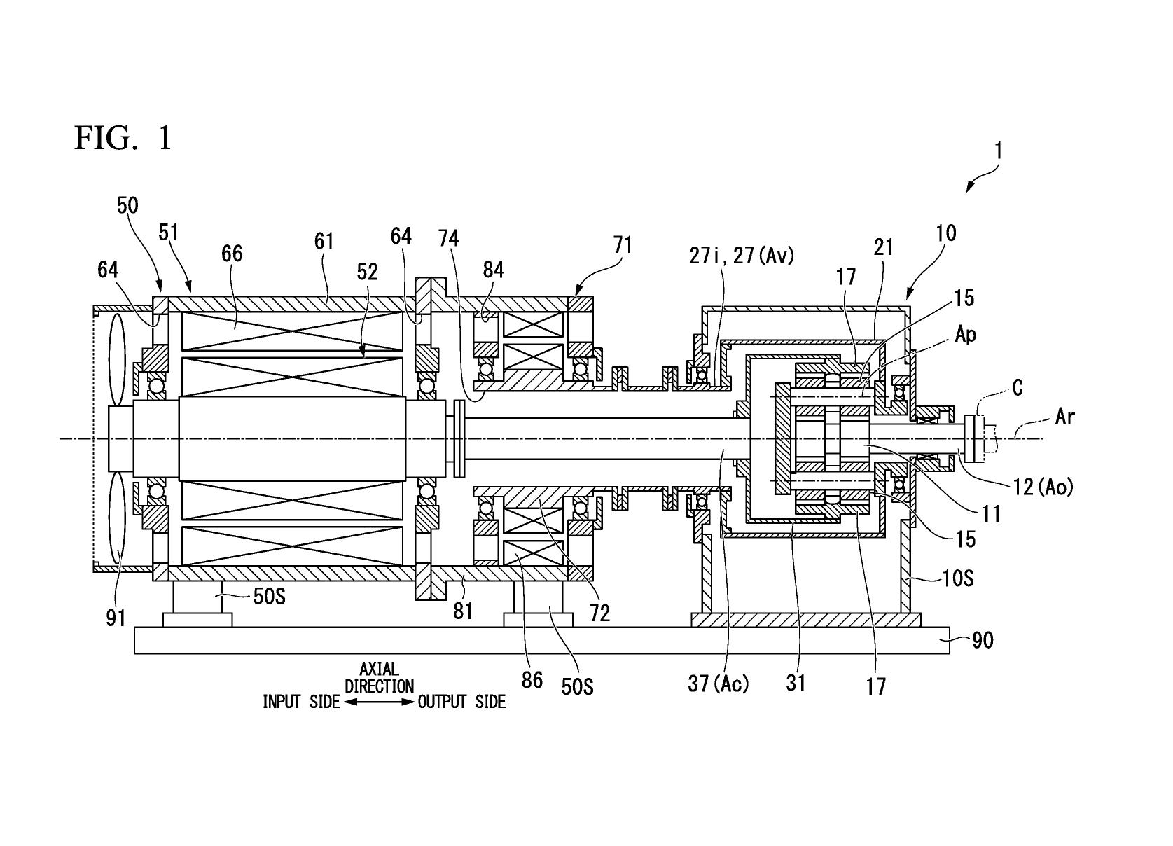

Hereinafter, a variable-speed speed-up mechanism 1 manufactured by a method for manufacturing a variable-speed speed-up mechanism S1 of an embodiment of the present invention will be described in detail with reference to the drawings. As shown in FIG. 1, the variable-speed speed-up mechanism 1 of the present embodiment includes an electric device 50 which generates a rotational driving force, and a transmission device 10 which changes the speed of a rotational driving force generated by the electric device 50 and transmits the rotational driving force to a target to be driven. The variable-speed speed-up mechanism 1 can be employed in, for example, a fluid mechanical system, such as a compressor system. The variable-speed speed-up mechanism 1 is connected to a compressor C that serves as the target to be driven.

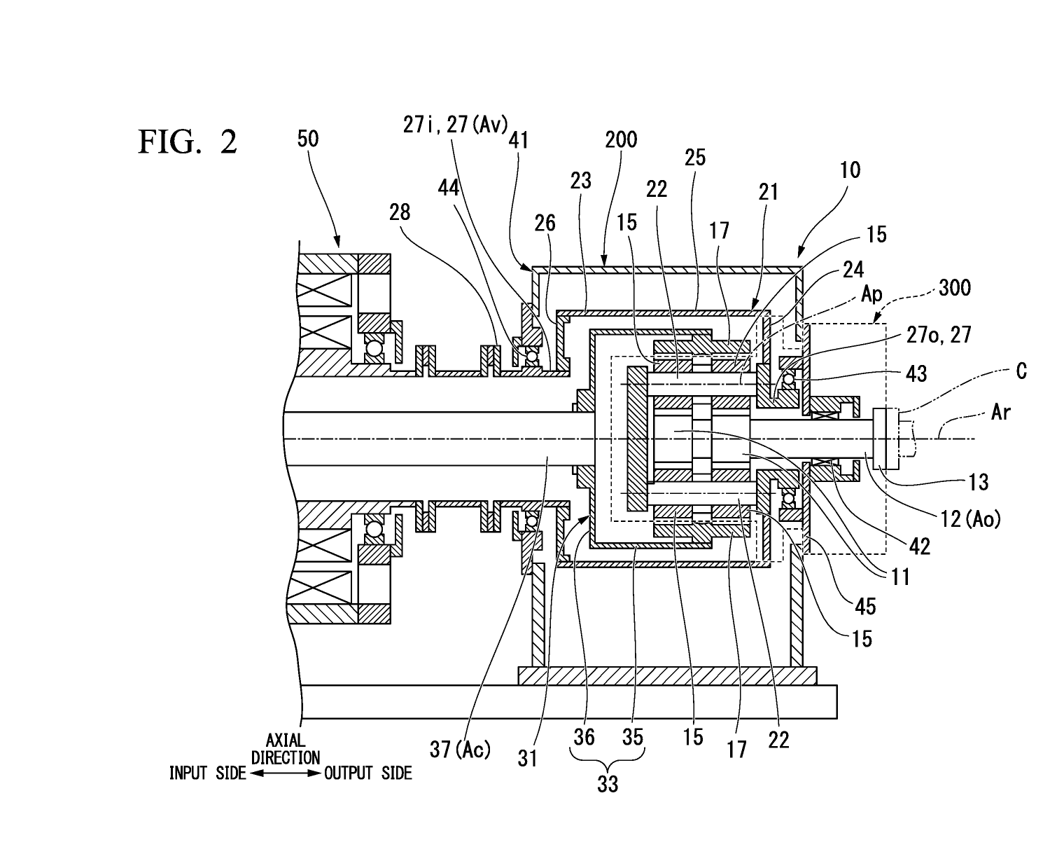

The transmission device 10 is a planetary gear transmission device. As shown in FIG. 2, the transmission device 10 has a sun gear 11, a plurality of planetary gears 15, an internal gear 17, a planetary gear carrier 21, an internal gear carrier 31, and a transmission device casing 41.

The sun gear 11 rotates around an axis line Ar that extends in a horizontal direction. The transmission device casing 41 covers the sun gear 11, the plurality of planetary gears 15, the internal gear 17, the planetary gear carrier 21, and the internal gear carrier 31.

Hereinafter, a direction in which the axis line Ar extends is an axial direction, one side in the axial direction is an output side, and the side opposite to the output side is an input side. In addition, a radial direction around the axis line Ar is simply referred to as a radial direction.

The sun gear shaft 12 is fixed to the sun gear 11. The sun gear shaft 12 has a columnar shape around the axis line Ar. The sun gear shaft 12 extends from the sun gear 11 to the output side in the axial direction. A connection flange 13 is formed in an output side end portion of the sun gear shaft 12. For example, a rotor of the compressor C that serves as the target to be driven is connected to the connection flange 13. The sun gear shaft 12 is supported by a sun gear bearing 42 disposed on the output side of the sun gear 11 so as to be rotatable around the axis line Ar. The sun gear bearing 42 is attached to the output side of an annular casing flange 45 which widens radially outward. The casing flange 45 is attachable to and detachable from the transmission device casing 41.

The planetary gear 15 meshes with the sun gear 11. The planetary gear 15 revolves around the axis line Ar and rotates around a center line Ap thereof.

The internal gear 17 meshes with the plurality of planetary gears 15. In the internal gear 17, a plurality of teeth are arranged annularly around the axis line Ar.

The planetary gear carrier 21 supports the plurality of planetary gears 15 so as to be capable of revolving around the axis line Ar and rotating around the center line Ap of the planetary gear 15 thereof. The planetary gear carrier 21 includes a planetary gear shaft 22, a planetary gear carrier main body 23, and a planetary gear carrier shaft 27.

The planetary gear shaft 22 is provided for each of the plurality of planetary gears 15. The planetary gear shaft 22 penetrates the center line Ap of the planetary gear 15 in the axial direction and supports the planetary gear 15 so as to be rotatable around the center line Ap.

The planetary gear carrier main body 23 fixes mutual positions of the plurality of planetary gear shafts 22. The planetary gear carrier main body 23 includes a planetary gear output side arm portion 24, a planetary gear cylinder portion 25, and a planetary gear input side arm portion 26.

The planetary gear output side arm portion 24 extends radially outward from the plurality of planetary gear shafts 22. The planetary gear cylinder portion 25 has a cylindrical shape around the axis line Ar. The planetary gear cylinder portion 25 extends from the radially outer end of the planetary gear output side arm portion 24 to the input side. The planetary gear cylinder portion 25 is attachable to and detachable from the planetary gear output side arm portion 24. The planetary gear input side arm portion 26 extends radially inward from the output side end of the planetary gear cylinder portion 25.

The planetary gear carrier shaft 27 is fixed to the planetary gear carrier main body 23. The planetary gear carrier shaft 27 extends in the axial direction around the axis line Ar. The planetary gear carrier shaft 27 includes an output side planetary gear carrier shaft 27o which extends from the planetary gear output side arm portion 24 to the output side, and an input side planetary gear carrier shaft 27i which extends from the planetary gear input side arm portion 26 to the input side. Both the output side planetary gear carrier shaft 27o and the input side planetary gear carrier shaft 27i form a cylindrical shape around the axis line Ar.

The output side planetary gear carrier shaft 27o is supported by a first planetary gear carrier bearing 43 disposed further on the output side than the planetary gear output side arm portion 24 so as to be rotatable around the axis line Ar. The first planetary gear carrier bearing 43 is attached to the casing flange 45 from the side opposite to the sun gear bearing 42 in the axial direction. The sun gear shaft 12 is inserted into an inner circumferential side of the output side planetary gear carrier shaft 27o.

The input side planetary gear carrier shaft 27i is supported by a second planetary gear carrier bearing 44 disposed further on the input side than the planetary gear input side arm portion 26 so as to be rotatable around the axis line Ar. The second planetary gear carrier bearing 44 is attached to the transmission device casing 41. An annular planetary gear flange 28 which widens radially outward is formed at the input side end of the input side planetary gear carrier shaft 27i.

The internal gear carrier 31 supports the internal gear 17 to be rotatable around the axis line Ar. The internal gear carrier 31 includes an internal gear carrier main body 33 to which the internal gear 17 is fixed and an internal gear carrier shaft 37 which is fixed to the internal gear carrier main body 33 and extends in the axial direction around the axis line Ar.

The internal gear carrier main body 33 includes an internal gear cylinder portion 35 which forms a cylindrical shape around the axis line Ar and has the internal gear 17 fixed to the inner circumferential side thereof, and an internal gear input side arm portion 36 which extends radially inward from the input side end of the internal gear cylinder portion 35.

The internal gear carrier shaft 37 having a columnar shape around the axis line Ar is disposed on the input side of the sun gear shaft 12 having a columnar shape around the axis line Ar. The internal gear input side arm portion 36 of the internal gear carrier main body 33 is fixed to the internal gear carrier shaft 37. The input side part of the internal gear carrier shaft 37 is inserted into the inner circumferential side of the cylindrical input side planetary gear carrier shaft 27i.

The transmission device 10 of the present embodiment is divided into a main body portion 200 and a gear unit portion 300. The gear unit portion 300 is attachable to and detachable from the main body portion 200.

The main body portion 200 includes the internal gear 17, the internal gear carrier 31, a part of the planetary gear carrier 21, and the transmission device casing 41. Specifically, the main body portion 200 of the present embodiment includes the planetary gear shaft 22, the planetary gear cylinder portion 25, the planetary gear input side arm portion 26, the input side planetary gear carrier shaft 27i, as a part of the planetary gear carrier 21.

The gear unit portion 300 includes the sun gear 11, the sun gear shaft 12, the planetary gear 15, a part of the planetary gear carrier 21, the first planetary gear carrier bearing 43, the casing flange 45, and the sun gear bearing 42. Specifically, the gear unit portion 300 of the present embodiment has the planetary gear output side arm portion 24 and the output side planetary gear carrier shaft 27o, as a part of the planetary gear carrier 21.

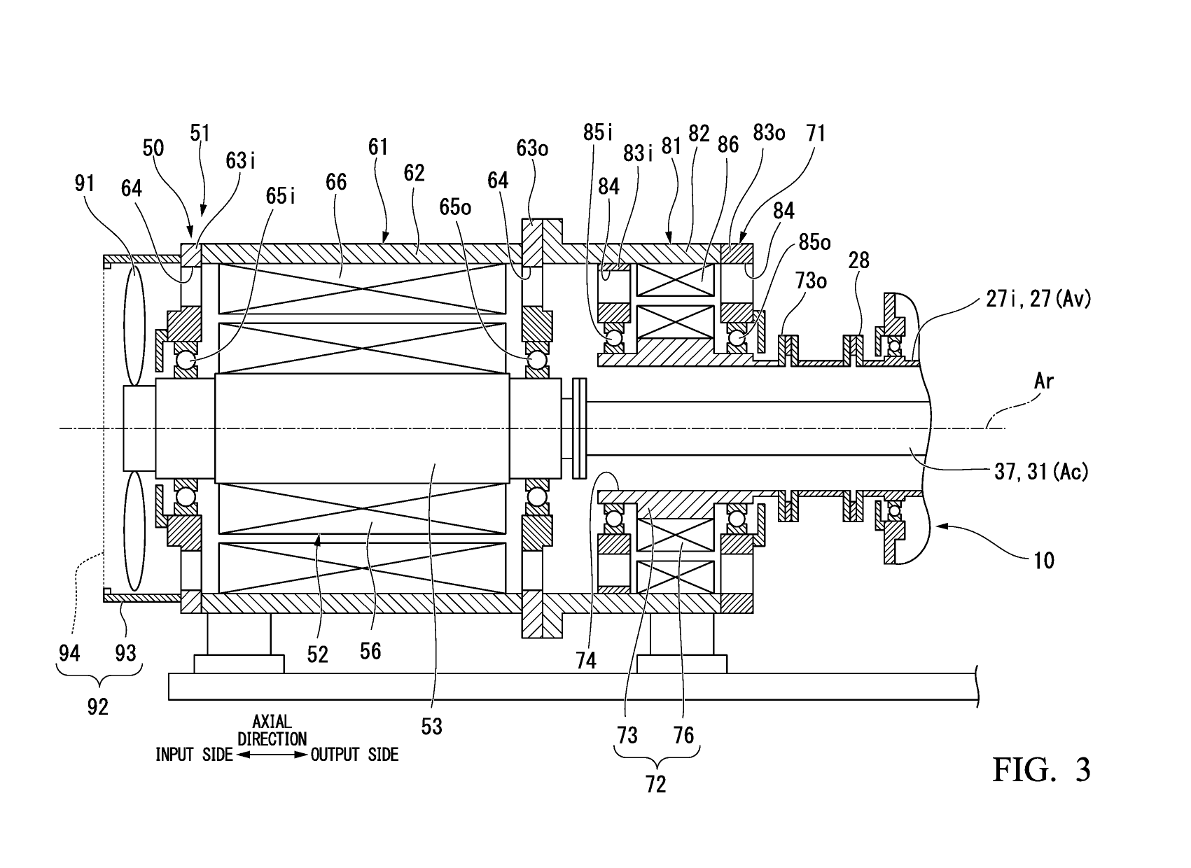

As shown in FIG. 3, the electric device 50 includes a constant-speed electric motor 51 which rotates and drives the internal gear carrier shaft 37 at a constant speed, and a variable-speed electric motor 71 which rotates and drive the input side planetary gear carrier shaft 27i at any rotational speed.

The internal gear carrier shaft 37 is a constant-speed input shaft Ac which rotates at a constant speed by a driving force of the constant-speed electric motor 51. The input side planetary gear carrier shaft 27i is a variable-speed input shaft Av which rotates at any rotational speed by the driving force of the variable-speed electric motor 71.

In the variable-speed speed-up mechanism 1, by changing the rotational speed of the variable-speed electric motor 71, it is possible to change the rotational speed of an output shaft Ao of the transmission device 10 connected to the target to be driven.

The electric device 50 is supported by a frame 90 by an electric device support unit 50S. The transmission device 10 is supported by the frame 90.

The constant-speed electric motor 51 rotates and drives the internal gear carrier shaft 37 of the transmission device 10. The variable-speed electric motor 71 rotates and drives the input side planetary gear carrier shaft 27i of the transmission device 10. The electric device 50 includes a cooling fan 91 for cooling the constant-speed electric motor 51 and a fan cover 92 which covers the cooling fan 91.

In the present embodiment, the constant-speed electric motor 51 is, for example, a four-pole three-phase induction electric motor. In addition, the variable-speed electric motor 71 is a six-pole three-phase induction electric motor having more poles than the constant-speed electric motor 51. In addition, the specifications of the constant-speed electric motor 51 and the variable-speed electric motor 71 are not limited thereto, and the specifications can be appropriately changed.

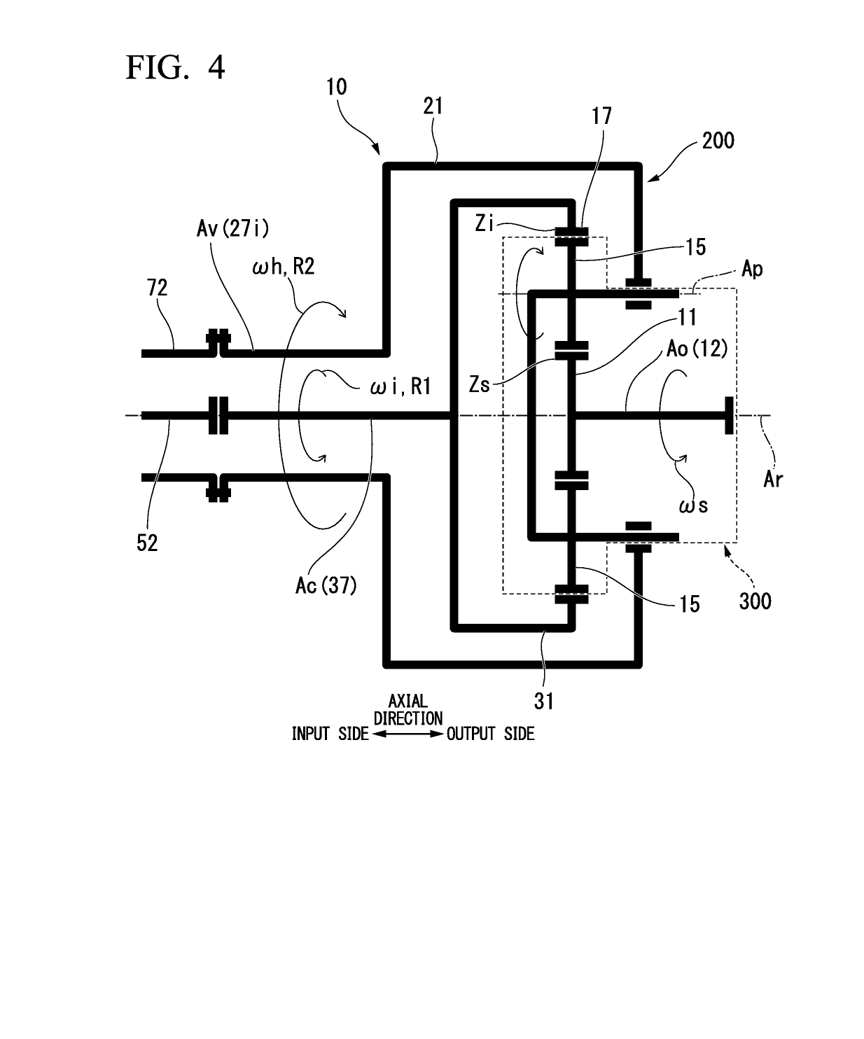

The constant-speed electric motor 51 includes a constant-speed rotor 52, a constant-speed stator 66, and a constant-speed electric motor casing 61. The constant-speed electric motor 51 rotates and drives the constant-speed rotor 52 (internal gear 17) in a first direction R1 (refer to FIG. 4, positive direction) in a circumferential direction of the axis line Ar. As the constant-speed rotor 52 rotates in the first direction R1, the internal gear carrier shaft 37 and the internal gear carrier 31 rotate in the first direction R1.

The constant-speed rotor 52 rotates around the axis line Ar. The constant-speed rotor 52 is directly or indirectly connected to the internal gear carrier shaft 37 which is the constant-speed input shaft Ac of the transmission device 10. The constant-speed rotor 52 includes a constant-speed rotor shaft 53 which forms a columnar shape around the axis line Ar, and a conductor 56 which is fixed to the outer circumference of the constant-speed rotor shaft 53. The cooling fan 91 is fixed to the input side end of the constant-speed rotor shaft 53.

The constant-speed stator 66 is disposed on the outer circumferential side of the constant-speed rotor 52. The constant-speed stator 66 is disposed on the radially outside of the conductor 56 of the constant-speed rotor 52. The constant-speed stator 66 is formed of a plurality of coils.

In the constant-speed electric motor casing 61, the constant-speed stator 66 is fixed to the inner circumferential side. The constant-speed electric motor casing 61 includes a constant-speed casing main body 62 and lids 63i and 63o. The constant-speed casing main body 62 has a cylindrical shape around the axis line Ar. In the constant-speed casing main body 62, the constant-speed stator 66 is fixed to the inner circumferential side. The lids 63i and 63o block both axial ends of the cylindrical constant-speed casing main body 62. Constant-speed rotor bearings 65i and 65o which support the constant-speed rotor shaft 53 to be rotatable around the axis line Ar, are attached to each of the lids 63i and 63o. A plurality of openings 64 which penetrate in the axial direction are formed in each of the lids 63i and 63o at positions further on the radially outside than the constant-speed rotor bearing 65i.

The input side end of the constant-speed rotor shaft 53 protrudes to the input side from the lid 63i on the input side of the constant-speed electric motor casing 61. The cooling fan 91 is fixed to the input side end of the constant-speed rotor shaft 53.

When the constant-speed rotor 52 rotates, the cooling fan 91 also rotates integrally with the constant-speed rotor 52. The fan cover 92 includes a cylindrical cover main body 93 which is disposed on the outer circumferential side of the cooling fan 91, and an air circulating plate 94 which is attached to the opening 64 on an inlet side of the cover main body 93 and has a plurality of air holes formed therein. The fan cover 92 is fixed to the lid 63i on the input side of the constant-speed electric motor casing 61.

The variable-speed electric motor 71 includes a variable-speed rotor 72, a variable-speed stator 86, and a variable-speed electric motor casing 81. The variable-speed electric motor 71 can rotate and drive the variable-speed rotor 72 (planetary gear carrier 21) in the first direction R1 in the circumferential direction of the axis line Ar and in a second direction R2 (refer to FIG. 4) in the direction opposite to the first direction R1. In other words, the variable-speed electric motor 71 is capable of rotating forward and reversely.

The variable-speed electric motor 71 functions as a generator by rotating the variable-speed rotor 72 in the first direction R1. A state where the variable-speed electric motor 71 functions as a generator is referred to as a generator mode. In other words, the variable-speed rotor 72 of the variable-speed electric motor 71 rotates in the first direction R1 in the generator mode.

The variable-speed electric motor 71 functions as an electric motor by rotating the variable-speed rotor 72 in the second direction R2 opposite to the first direction R1. A state where the variable-speed electric motor 71 functions as an electric motor is referred to as an electric motor mode. In other words, the variable-speed rotor 72 of the variable-speed electric motor 71 rotates in the second direction R2 in the electric motor mode.

As the variable-speed rotor 72 rotates in the first direction R1, the planetary gear carrier shaft 27 and the planetary gear carrier 21 rotate in the first direction R1.

The variable-speed rotor 72 rotates around the axis line Ar. The variable-speed rotor 72 is directly or indirectly connected to the input side planetary gear carrier shaft 27i which is the variable-speed input shaft Av. The variable-speed rotor 72 includes a variable-speed rotor shaft 73 and a conductor 76 which is fixed to the outer circumference of the variable-speed rotor shaft 73. The variable-speed rotor shaft 73 has a cylindrical shape around the axis line Ar and has a shaft insertion hole 74 which penetrates in the axial direction. An internal gear carrier shaft 37 which is the constant-speed input shaft Ac is inserted into the shaft insertion hole 74 of the variable-speed rotor shaft 73. An annular variable-speed flange 73o which widens radially outward is formed at the output side end of the variable-speed rotor shaft 73.

The variable-speed stator 86 is disposed on the outer circumferential side of the variable-speed rotor 72. The variable-speed stator 86 is disposed on the radially outside of the conductor 76 of the variable-speed rotor 72. The variable-speed stator 86 is formed of a plurality of coils.

In the variable-speed electric motor casing 81, the variable-speed stator 86 is fixed to the inner circumferential side. The variable-speed electric motor casing 81 has a variable speed casing main body 82, an output side lid 83o, and an inlet side lid 83i. The variable speed casing main body 82 has a cylindrical shape around the axis line Ar. In the variable speed casing main body 82, the variable-speed stator 86 is fixed to the inner circumferential side. The output side lid 83o blocks the output side end of the cylindrical variable speed casing main body 82. The inlet side lid 83i is disposed further on the input side than the variable-speed stator 86 and fixed to the inner circumferential side of the cylindrical variable speed casing main body 82. Variable-speed rotor bearings 85i and 85o which support the variable-speed rotor shaft 73 to be rotatable around the axis line Ar, are attached to each of the lids 83i and 83o. A plurality of openings 84 which penetrate in the axial direction are formed in each of the lids 83i and 83o at positions further on the radially outside than the variable-speed rotor bearings 85i and 85o.

By the plurality of openings 84 formed in the each of lids 83i and 83o of the variable-speed electric motor casing 81 and the plurality of openings 64 formed in each of the lids 63i and 63o of the constant-speed electric motor casing 61, a space in the variable-speed electric motor casing 81 and a space in the constant-speed electric motor casing 61 communicate with each other.

In addition, in the variable-speed speed-up mechanism 1 of the present embodiment, the constant-speed rotor 52, the variable-speed rotor 72, and the sun gear shaft 12 are disposed on the same axis line Ar.

Here, the relationship between the number of teeth of each gear of the transmission device 10 and the rotational speed of each shaft of the transmission device 10 will be described with reference to FIG. 4.

The rotational speed of the sun gear shaft 12 that serves as the output shaft Ao is ωs, the rotational speed of the internal gear carrier shaft 37 that serves as the constant-speed input shaft Ac is ωi, and the rotational speed of the input side planetary gear carrier shaft 27i that serves as the variable-speed input shaft Av is ωh. In addition, the number of teeth of the sun gear 11 is Zs, and the number of teeth of the internal gear 17 is Zi.

In this case, the relationship between the number of teeth of each gear and the rotational speed of each shaft of the transmission device 10 can be expressed by the following expression (1).

ωs/ωi=ωh/ω−(1−ωh/ωi)×Zi/Zs (1)

In a case where the constant-speed electric motor 51 is a four-pole induction electric motor and the power supply frequency is 50 Hz, the rotational speed ωi (rated rotational speed) of the constant-speed rotor 52 (constant-speed input shaft Ac) is 1500 rpm. In addition, in a case where the variable-speed electric motor 71 is a six-pole induction electric motor and the power supply frequency is 50 Hz, the highest rotational speed ωh (rated rotational speed) of the variable-speed rotor 72 (variable-speed input shaft Av) is 900 rpm. Further, a ratio Zi/Zs of the number of teeth Zs of the sun gear 11 to the number of teeth Zi of the internal gear 17 are assumed to be 4.

In this case, when the direction of rotation of the constant-speed rotor 52 (internal gear 17) is defined as forward rotation (rotation in the first direction) and the direction of rotation of the variable-speed rotor 72 (planetary gear carrier 21) is the highest rotational speed (−900 rpm) in a direction (rotation in the second direction) reverse to the rotation of the constant-speed rotor 52, the rotational speed ωs of the sun gear shaft 12 which is the output shaft Ao is −10500 rpm. The rotational speed (−10500 rpm) is the highest rotational speed of the sun gear shaft 12.

In other words, in the transmission device 10 of the present embodiment, the internal gear 17 that corresponds to the constant-speed input shaft Ac is forwardly rotated at +1500 rpm and the planetary gear carrier 21 that corresponds to the variable-speed input shaft Av is reversely rotated at −900 rpm, and accordingly, the rotational speed ωs of the output shaft Ao becomes the highest rotational speed.

When assuming that the variable speed range of the variable-speed input shaft Av is from −900 rpm to +900 rpm, as the rotational speed of the variable-speed input shaft Av approaches +900 rpm, the rotational speed ωs of the output shaft Ao becomes low.

When the direction of the rotation of the constant-speed rotor 52 is set to the forward rotation and the direction of the rotation of the variable-speed rotor 72 is the lowest rotational speed (−90 rpm) in a direction reverse to the rotation of the constant-speed rotor 52, the rotational speed of the sun gear shaft 12 becomes −6450 rpm.

In a case where the rotational speed (rated rotational speed) of the constant-speed rotor 52 is +1500 rpm and the rotational speed of the variable-speed rotor 72 in the electric motor mode is controlled within the range of −300 to −900 rpm by frequency control by the rotational speed conversion unit 101, that is, in a case where the frequency of the electric power to be supplied to the variable-speed electric motor 71 is controlled within the range of 16.7 Hz to 50 Hz, the rotational speed of the sun gear shaft 12 which is the output shaft Ao can be controlled to the range of −7500 to −10500 rpm. The range is a variable speed range of the sun gear shaft 12 which is the output shaft Ao of the variable-speed speed-up mechanism 1, and the variable-speed speed-up mechanism 1 generally rotates the output shaft Ao within the variable speed range.

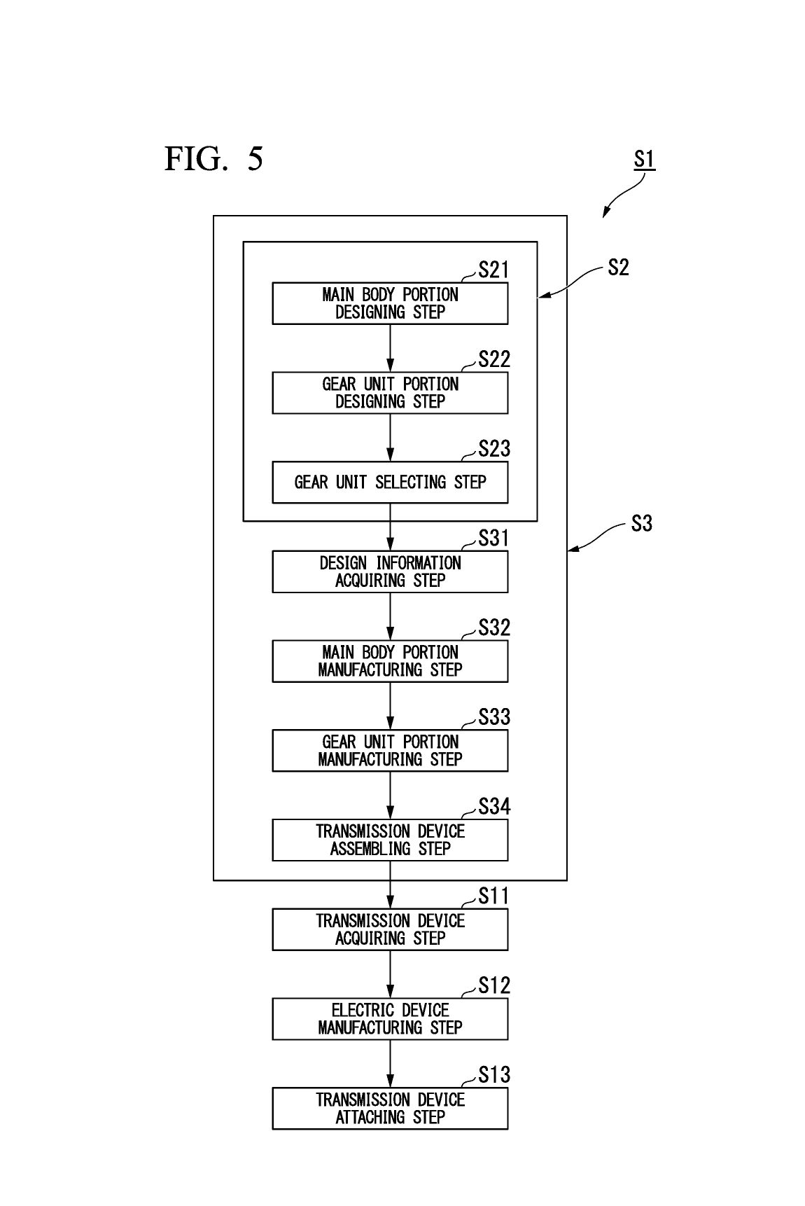

Next, the method for manufacturing a variable-speed speed-up mechanism S1 of the present embodiment will be described with reference to FIG. 5. The method for manufacturing a variable-speed speed-up mechanism S1 is for manufacturing the variable-speed speed-up mechanism 1 using the transmission device 10 manufactured by a method for manufacturing a transmission device S3. The method for manufacturing a transmission device S3 is for manufacturing the transmission device 10 according to the designed information after designing the main body portion 200 and the gear unit portion 300 by a method for designing a transmission device S2. Therefore, the method for designing a transmission device S2, the method for manufacturing a transmission device S3 and the method for manufacturing a variable-speed speed-up mechanism S1 will be described in order.

The method for designing a transmission device S2 of the present embodiment is for designing one main body portion 200 and a plurality of gear unit portions 300 having different gear ratios. The method for designing a transmission device S2 includes a main body portion designing step S21, a gear unit portion designing step S22, and a gear unit portion selecting step S23.

In the main body portion designing step S21, the main body portion 200 is designed. In the main body portion designing step S21, only one main body portion 200 is designed.

In the gear unit portion designing step S22, the plurality of gear unit portions 300 are designed to have different gear ratios and have the same outer diameter. In the gear unit portion designing step S22, all of the plurality of gear unit portions 300 are designed to have the same outer diameter. In the gear unit portion designing step S22, the gear ratio is determined with the revolving rotational speed of the planetary gears 15 of all of the gear unit portions 300 to be designed to be constant. In the gear unit portion designing step S22, the planetary gears 15 of all of the gear unit portions 300 are designed so as to be capable of meshing with one internal gear 17.

Specifically, as described in the following table, for example, when designing three types of gear unit portions 300, with an internal tooth fitting center diameter DL which is an inner diameter of the internal gear 17 and a planetary revolving gear center diameter Dv of the planetary gear 15 are made constant. Under these conditions, the rotational speed ωs, a torque Ts, a center diameter ds, and a force fs which acts on a tooth surface of the sun gear 11 are determined. From the values, the center diameter of the planetary gear 15 is also determined.

TABLE 1

| | | Gear unit | Gear unit | Gear unit |
|---|---|---|---|---|
| Specifications | | portion A | portion B | portion C |
| Internal tooth fitting center | | DL | | |
| diameter | | | | |
| Planetary revolving gear center | | Dv | | |
| diameter | | | | |
| Sun gear | Rotational speed | ωsA | ωsB | ωsC |
| | Torque | TsA | TsB | TsC |
| | Center diameter | dsA | dsB | dsC |
| | Force which acts on | fsA | fsB | fsC |
| | tooth surface | | | |

By designing the plurality of gear unit portions 300 as described in the table above, it is possible to obtain the design information of the gear unit portions 300 that respectively correspond to different outputs and rotational speeds.

In addition, even when the output is the same and the rotational speed of the target to be driven is different, the force which acts on the tooth surface of the sun gear 11 becomes constant. Specifically, the rotational speeds of the target to be drivens having different rotational speeds are ω1 and ω2, the torques are Ts1 and Ts2, and the diameters of the corresponding sun gears 11 are ds1 and ds2. In addition, the forces which act on the tooth surface of the sun gear 11 are fs1 and fs2, respectively.

At this time, the following expression is established with respect to an output W.

W∝ωs1×Ts1=ωs2×Ts2 (2)

Meanwhile, the following expression is established with respect to the torques Ts1 and Ts2.

Ts1 ∝fs1×ds1,Ts2 ∝fs2×ds2 (3)

When substituting the expression (3) into the expression (2),

ωs1×fs1×ds1=ωs2×fs2×ds2 (4)

Here, when the internal tooth fitting center diameter DL of the internal gear 17 is constant, since the speed of a constant speed motor which is a main driving machine is constant, the internal diameter circumferential speed VI of the internal gear 17 also becomes constant. As a result, the circumferential speed of the sun gear 11 is also the same as the internal diameter circumferential speed of the internal gear 17. Therefore, the following expression is established.

VI∝ωs1×ds1=ωs2×ds2 (5)

When substituting the expression (5) into the expression (4),

ωs1×fs1×ds1=ωs1×fs2×ds1

Therefore, fs1=fs2. In other words, even when the rotational speed of the target to be driven changes, the force which acts on the tooth surface of the sun gear 11 becomes constant.

From the expression above, even when the rotational speed of the target to be driven changes, the internal tooth fitting center diameter DL is made constant and the diameter of the sun gear 11 is changed to a value appropriate for rotational speed (naturally, according to this, the diameter of the planetary gear 15 changes), the force which acts on the tooth surface of the sun gear 11 becomes the same. Therefore, even when the rotational speed of the target to be driven changes, simply by replacing the gear unit portion with the gear unit portion 300 appropriate therefor, it is possible to respond to the specification change of the rotational speed of the target to be driven without changing the main body portion 200 of the transmission device 10.

Next, in the gear unit portion selecting step S23, one gear unit portion 300 is selected from the plurality of gear unit portions 300 designed in the gear unit portion designing step S22. In the gear unit portion selecting step S23, one gear unit portion 300 is selected in accordance with the required target to be driven output and the rotational speed.

The method for manufacturing a transmission device S3 is for manufacturing the transmission device 10 according to the design information obtained by the method for designing a transmission device S2. The method for manufacturing a transmission device S3 of the present embodiment includes a design information acquiring step S31, a main body portion manufacturing step S32, a gear unit portion manufacturing step S33, and a transmission device assembling step S34.

The design information acquiring step S31 acquires the design information of the main body portion 200 and the gear unit portion 300 according to the method for designing a transmission device S2. The design information acquiring step S31 acquires the design information of the main body portion 200 designed in the main body portion designing step S21. In the design information acquiring step S31, the design information of one gear unit portion 300 selected in the gear unit portion selecting step S23 is acquired.

The main body portion manufacturing step S32 is for manufacturing the main body portion 200 according to the design information of the main body portion 200 acquired in the design information acquiring step S31. In the main body portion manufacturing step S32, the internal gear 17, the internal gear carrier 31, a part of the planetary gear carrier 21, and the transmission device casing 41 are respectively assembled to manufacture the main body portion 200.

The gear unit portion manufacturing step S33 is for manufacturing the gear unit portion 300 according to the design information of the gear unit portion 300 acquired in the design information acquiring step S31. In the gear unit portion manufacturing step S33, the sun gear 11, the sun gear shaft 12, the planetary gear 15, a part of the planetary gear carrier 21, the first planetary gear carrier bearing 43, the casing flange 45, and the sun gear bearing 42 are respectively assembled to manufacture the gear unit portion 300.

In the transmission device assembling step S34, the gear unit portion 300 manufactured in the gear unit portion manufacturing step S33 is attached and assembled to the main body portion 200 manufactured in the main body portion manufacturing step S32. In the transmission device assembling step S34, the transmission device 10 is manufactured by incorporating already assembled gear unit portion 300 into the already assembled main body portion 200.

The method for manufacturing a variable-speed speed-up mechanism S1 is for manufacturing the variable-speed speed-up mechanism 1 using the transmission device 10 manufactured by the method for manufacturing a transmission device S3. The method for manufacturing a variable-speed speed-up mechanism S1 of the present embodiment includes a transmission device acquiring step S11, an electric device manufacturing step S12, and a transmission device attaching step S13.

The transmission device acquiring step S11 acquires the transmission device 10 according to the method for manufacturing a transmission device S3. In other words, in the transmission device acquiring step S11, the transmission device 10 manufactured in a state where one gear unit portion 300 is incorporated is acquired.

In the electric device manufacturing step S12, the electric device 50 including the constant-speed electric motor 51 and the variable-speed electric motor 71 is manufactured. In the electric device manufacturing step S12 of the present embodiment, the constant-speed electric motor 51 and the variable-speed electric motor 71 are manufactured, respectively. In the electric device manufacturing step S12, the integrated electric device 50 is manufactured by combining the constant-speed electric motor 51 and the variable-speed electric motor 71 which are manufactured respectively to each other.

In the transmission device attaching step S13, the transmission device 10 is attached to the electric device 50 manufactured in the electric device manufacturing step S12 such that the internal gear carrier shaft 37 forms the constant-speed input shaft Ac and the planetary gear carrier shaft 27 forms the variable-speed input shaft Av. In the transmission device attaching step S13, the internal gear carrier shaft 37 is connected to the constant-speed rotor 52. In the transmission device attaching step S13, the planetary gear carrier shaft 27 is connected to the variable-speed rotor 72. Accordingly, the variable-speed speed-up mechanism 1 in which the sun gear shaft 12 is set as the output shaft Ao connected to the compressor C is manufactured.

According to the above-described method for designing a transmission device S2, a part having many gears, such as the planetary gear 15 or the sun gear 11, can be designed as the gear unit portion 300. By designing the plurality of gear unit portions 300 with the same outer shape but different gear ratios, it is possible to standardize the design of the main body portion 200 regardless of the required gear ratio. In other words, without changing the design of the main body portion 200, it is possible to obtain the transmission devices 10 having different gear ratios simply by designing the plurality of gear unit portions 300 which is a part of the transmission device 10. Therefore, it is possible to obtain the design information of the plurality of transmission devices 10 adapted to the compressor C which requires different outputs or rotational speeds, without redesigning the entire transmission device 10 including a location to be connected to another device or the like. Accordingly, it is possible to obtain the transmission devices 10 having different gear ratios while limiting the production period and cost.

By designing the plurality of gear unit portions 300 with the revolving rotational speed of the planetary gear 15 to be constant, even in a case where the rotational speed of the compressor C changes, it is not necessary to adjust the gear specification of the internal gear 17 transmitted to the planetary gear 15. Therefore, even in a case where the rotational speed of the compressor C changes, it is possible to obtain the transmission device 10 that corresponds to the compressor C simply by replacing the gear unit portion 300 while limiting the production period and cost.

According to the above-described method for manufacturing a transmission device S3, it is possible to manufacture the transmission device 10 according to the design information of the transmission device 10 designed while limiting the production period and cost. Therefore, the transmission device 10 can be manufactured in a short period of time. Further, the main body portion 200 can be standardized, and the manufacturing cost of the main body portion 200 can be limited. Furthermore, even with respect to the transmission device 10 already used, it is possible to respond to the compressor C of which the specifications, such as output and rotational speed, are changed, simply by replacing the gear unit portion 300.

According to the above-described method for manufacturing a variable-speed speed-up mechanism S1, the variable-speed speed-up mechanism 1 can be manufactured using the transmission device 10 manufactured in a short period of time. Therefore, it is possible to manufacture the variable-speed speed-up mechanism 1 in a short period of time by limiting the manufacturing period of the transmission device 10.

Above, although the embodiments of the present invention have been described in detail with reference to the drawings, each of the configurations and combinations thereof in each of the embodiments are merely examples, and additions, omissions, substitutions, and other changes of configurations are possible within the scope not departing from the gist of the present invention. Further, the present invention is not limited by the embodiments, but is limited only by the claims.

In addition, in the above-described embodiment, a four-pole three-phase induction electric motor is exemplified as the constant-speed electric motor 51 appropriate for rotating the compressor C at high speed, and a six-pole three-phase induction electric motor is exemplified as the variable-speed electric motor 71 appropriate for variably changing the rotational speed of the compressor C within a certain range. However, in a case where it is not necessary to rotate the target to be driven at high speed, other types of electric motors may be used as the constant-speed electric motor 51 or the variable-speed electric motor 71.

In addition, in the above-described embodiment, the shaft insertion hole 74 is formed in the variable-speed rotor 72 and the constant-speed rotor 52 is inserted into the shaft insertion hole 74, but the shaft insertion hole 74 may be formed in the constant-speed rotor 52 and the variable-speed rotor 72 may be inserted into the shaft insertion hole 74.

In addition, in the above-described embodiment, the constant-speed rotor 52, the variable-speed rotor 72, and the sun gear shaft 12 are disposed on the same axis line Ar, but the invention is not limited thereto. For example, the variable-speed electric motor 71 may be disposed such that the axis line Ar of the variable-speed rotor 72 is parallel to the axis line Ar of the constant-speed rotor 52 and is at a different position.

Further, in the transmission device 10 of the present embodiment, the planetary gear input side arm portion 26 may be provided with an idle gear. In this case, the variable-speed electric motor 71 can rotate the variable-speed rotor 72 (planetary gear carrier 21) in the same direction as the constant-speed electric motor 51 in the first direction R1 which is considered as a normal direction.

### INDUSTRIAL APPLICABILITY

According to the above-described method for designing the transmission device S2, it is possible to obtain transmission devices 10 having different gear ratios while limiting the production period and cost.

### REFERENCE SIGNS LIST

1 VARIABLE-SPEED SPEED-UP MECHANISM
10 TRANSMISSION DEVICE
Ar AXIS LINE
11 SUN GEAR
12 SUN GEAR SHAFT
Ao OUTPUT SHAFT
13 CONNECTION FLANGE
Ap CENTER LINE
15 PLANETARY GEAR
17 INTERNAL GEAR
21 PLANETARY GEAR CARRIER
22 PLANETARY GEAR SHAFT
23 PLANETARY GEAR CARRIER MAIN BODY
24 PLANETARY GEAR OUTPUT SIDE ARM PORTION
25 PLANETARY GEAR CYLINDER PORTION
26 PLANETARY GEAR INPUT SIDE ARM PORTION
27 PLANETARY GEAR CARRIER SHAFT
27o OUTPUT SIDE PLANETARY GEAR CARRIER SHAFT
27i INPUT SIDE PLANETARY GEAR CARRIER SHAFT
Av VARIABLE-SPEED INPUT SHAFT
31 INTERNAL GEAR CARRIER
33 INTERNAL GEAR CARRIER MAIN BODY
35 INTERNAL GEAR CYLINDER PORTION
36 INTERNAL GEAR INPUT SIDE ARM PORTION
37 INTERNAL GEAR CARRIER SHAFT
Ac CONSTANT-SPEED INPUT SHAFT
41 TRANSMISSION DEVICE CASING
42 SUN GEAR BEARING
43 FIRST PLANETARY GEAR CARRIER BEARING
44 SECOND PLANETARY GEAR CARRIER BEARING
45 CASING FLANGE
200 MAIN BODY PORTION
300 GEAR UNIT PORTION
50 ELECTRIC DEVICE
51 CONSTANT-SPEED ELECTRIC MOTOR
52 CONSTANT-SPEED ROTOR
53 CONSTANT-SPEED ROTOR SHAFT
56 CONDUCTOR
66 CONSTANT-SPEED STATOR
61 CONSTANT-SPEED ELECTRIC MOTOR CASING
62 CONSTANT-SPEED CASING MAIN BODY
63i, 63o LID
64 OPENING
65i, 65o CONSTANT-SPEED ROTOR BEARING
71 VARIABLE-SPEED ELECTRIC MOTOR
72 VARIABLE-SPEED ROTOR
73 VARIABLE-SPEED ROTOR SHAFT
74 SHAFT INSERTION HOLE
73o VARIABLE-SPEED FLANGE
76 CONDUCTOR
86 VARIABLE-SPEED STATOR
81 VARIABLE-SPEED ELECTRIC MOTOR CASING
82 TRANSMISSION DEVICE CASING MAIN BODY
83o OUTPUT SIDE LID
83i INLET SIDE LID
84 OPENING
85i, 85o VARIABLE-SPEED ROTOR BEARING
91 COOLING FAN
92 FAN COVER
93 COVER MAIN BODY
94 AIR CIRCULATING PLATE
100 ROTATIONAL SPEED CONTROL DEVICE
SW1 FIRST SWITCH
SW2 SECOND SWITCH
120 CONTROL UNIT
10S TRANSMISSION DEVICE INSTRUCTION UNIT
50S ELECTRIC DEVICE SUPPORT UNIT
90 FRAME
C COMPRESSOR
S1 METHOD FOR MANUFACTURING VARIABLE-SPEED SPEED-UP MECHANISM
S2 METHOD FOR DESIGNING TRANSMISSION DEVICE
S21 MAIN BODY PORTION DESIGNING STEP
S22 GEAR UNIT PORTION DESIGNING STEP
S23 GEAR UNIT PORTION SELECTING STEP
S3 METHOD FOR MANUFACTURING TRANSMISSION DEVICE
S31 DESIGN INFORMATION ACQUIRING STEP
S32 MAIN BODY PORTION MANUFACTURING STEP
S33 GEAR UNIT PORTION MANUFACTURING STEP
S34 TRANSMISSION DEVICE ASSEMBLING STEP
S11 TRANSMISSION DEVICE ACQUIRING STEP
S12 ELECTRIC DEVICE MANUFACTURING STEP
S13 TRANSMISSION DEVICE ATTACHING STEP

1. A method for designing a transmission device for changing a speed of a rotational driving force generated by an electric device which is configured to generate the rotational driving force and transmitting the rotational driving force to a target to be driven, the method comprising:
a main body portion designing step of designing a main body portion including an internal gear having a plurality of teeth which are annularly arranged around an axis line, an internal gear carrier shaft which is configured to extend in an axial direction around the axis line, and an internal gear carrier supporting the internal gear to be rotatable around the axis line;
a gear unit portion designing step of designing a plurality of gear unit portions each including a sun gear which is configured to rotate around the axis line, a sun gear shaft which is fixed to the sun gear and is configured to extend in the axial direction around the axis line, and a planetary gear which is capable of meshing with the sun gear, revolving around the axis line and rotating around a center line thereof, and meshing with the internal gear, so as to have different gear ratios and to have the same outer diameter; and
a gear unit portion selecting step of selecting one gear unit portion from the plurality of gear unit portions designed in the gear unit portion designing step.

2. The method for designing a transmission device according to claim 1,
wherein, in the gear unit portion designing step, the gear ratio is determined with the revolving rotational speed of the planetary gear to be constant.

3. A method for manufacturing a transmission device, comprising:
a design information acquiring step of acquiring design information of the main body portion and the gear unit portion according to the method for designing a transmission device according to claim 1;
a main body portion manufacturing step of manufacturing the main body portion according to the design information of the main body portion acquired in the design information acquiring step;
a gear unit portion manufacturing step of manufacturing the gear unit portion according to design information of the gear unit portion acquired in the design information acquiring step; and
a transmission device assembling step of attaching and assembling the gear unit portion manufactured in the gear unit portion manufacturing step to the main body portion manufactured in the main body portion manufacturing step.

4. A method for manufacturing a variable-speed speed-up mechanism, comprising:
a transmission device acquiring step of acquiring the transmission device according to the method for manufacturing the transmission device according to claim 3;
an electric device manufacturing step of manufacturing the electric device including a constant-speed electric motor having a constant-speed rotor which is configured to be connected directly or indirectly to a constant-speed input shaft of the transmission device, and a variable-speed electric motor having a variable-speed rotor which is configured to be connected directly or indirectly to the variable-speed input shaft of the transmission device; and
a transmission device attaching step of attaching the transmission device to the electric device manufactured in the electric device manufacturing step such that the sun gear shaft forms an output shaft connected to a target to be driven and the internal gear carrier shaft forms the constant-speed input shaft.

5. A method for manufacturing a transmission device, comprising:
a design information acquiring step of acquiring design information of the main body portion and the gear unit portion according to the method for designing a transmission device according to claim 2;
a main body portion manufacturing step of manufacturing the main body portion according to the design information of the main body portion acquired in the design information acquiring step;
a gear unit portion manufacturing step of manufacturing the gear unit portion according to design information of the gear unit portion acquired in the design information acquiring step; and
a transmission device assembling step of attaching and assembling the gear unit portion manufactured in the gear unit portion manufacturing step to the main body portion manufactured in the main body portion manufacturing step.

6. A method for manufacturing a variable-speed speed-up mechanism, comprising:
a transmission device acquiring step of acquiring the transmission device according to the method for manufacturing the transmission device according to claim 5;
an electric device manufacturing step of manufacturing the electric device including a constant-speed electric motor having a constant-speed rotor which is configured to be connected directly or indirectly to a constant-speed input shaft of the transmission device, and a variable-speed electric motor having a variable-speed rotor which is configured to be connected directly or indirectly to the variable-speed input shaft of the transmission device; and
a transmission device attaching step of attaching the transmission device to the electric device manufactured in the electric device manufacturing step such that the sun gear shaft forms an output shaft connected to a target to be driven and the internal gear carrier shaft forms the constant-speed input shaft.
